(19) United States
(12) Patent Application Publication
(10) Pub. No.: US 2005/0084603 A1
(43) Pub. Date: Apr. 21, 2005

(54) Stable chocolate confection containing one or more sugar shelled inclusions

(75) Inventors: John M. Kaiser, Manheim, PA (US); Brian Anthony, Lititz, PA (US); Dale Slesser, Mount Joy, PA (US); Eric Whitacre, Elizabeth, PA (US); Jacqueline Kramer, Stroudburg, PA (US); Keith Schafer, Easton, PA (US); David Prybylowski, Mendham, NJ (US)

Correspondence Address: FITZPATRICK CELLA HARPER & SCINTO, 30 ROCKEFELLER PLAZA, NEW YORK, NY, 10112, US

(73) Assignee: MARS, INCORPORATED, McLean, VA (US)

(21) Appl. No.: 10/923,870

(22) Filed: Aug. 24, 2004

Related U.S. Application Data
(60) Provisional application No. 60/498,340, filed on Aug. 26, 2003.
(60) Provisional application No. 60/497,898, filed on Aug. 25, 2003.

(51) Int. Cl. A23G 1/00

(52) U.S. Cl. 426/660

(57) ABSTRACT

A stable confection comprising a chocolate matrix having at least one sugar coated confectionery inclusion is disclosed. The confectionery inclusion comprises an outer sugar shell; a fat containing edible barrier layer substantially surrounded by the sugar shell and a fat-containing edible core surrounded by the barrier layer, the barrier layer containing at least about 0.5% less liquid fat at 25° C. and the edible core and a barrier layer: core weight ratio is at least about 0.1:1.

This application claims the benefit of U.S. provisional patent application No. 60/498,340, filed Aug. 26, 2003, and U.S. provisional patent application No. 60/497,898, filed Aug. 25, 2003.

### BACKGROUND OF THE INVENTION

1. Field of the Invention

The present invention relates to a stable confection having a chocolate matrix with at least one sugar shelled inclusion and a method of producing the same. Significantly, the inclusion comprises an outer sugar shell substantially surrounding a fat-containing edible barrier layer which surrounds an edible core having a fat composition that differs from the barrier layer. The confections have improved stability and, therefore, extended shelf life by virtue of a fat-containing barrier layer. The invention is especially useful for the inhibition of fat-related cosmetic defects on the surface of chocolate, which resemble fat bloom.

2. Related Background Art

Chocolate based confections are tremendously appreciated by consumers through out the world. In many instances, the manufacturers of chocolate confection products have experienced an increase in demand for these products with various inclusions. A particularly desired inclusion would be a sugar shelled confection. Well known exemplary sugar shelled confections include &M&M's® Brand Candies.

It has been discovered, however, that the inclusion in a chocolate matrix of sugar shelled confections having a fat containing core which is compositionally different than the chocolate matrix can result in visual and organoleptic defects over time. Without being bound to theory, it is believed that cracks develop in the sugar shelled inclusions and that fat from the core breaches through the cracks into the chocolate matrix. Such cracks may develop before or after the inclusions are placed in the chocolate matrix. In general, when you have two fat systems in contact with each other, the fats will migrate into each other. When a sugar shell separates two fat systems, the migration of fat will occur at any break in the shell and this is believed to result in concentration of fat at the location of the break.

In addition, the level of fat migration will tend to increase as the temperature increases, i.e., there is a greater amount of liquid fat. Moreover, when an inclusion is sugar shelled, a rise in temperature also results in a volumetric increase in the fat containing core which is constrained by the shell, particularly if the shell is a hard panned rigid sugar shell. This is believed to result in increased internal pressure that forces the liquid fat through the crack into the chocolate matrix. It is further believed that the liquid fat may act to transport a fat from the core which is non-compatible with cocoa butter, i.e., disrupts the crystal structure and ultimately has a deleterious effect on the appearance and/or organoleptic qualities of the chocolate matrix.

It has been found that this problem is particularly significant in chocolate confections that contain sugar shelled inclusions having a peanut based core, e.g. peanut creme or peanut butter. Specifically, the fat in the chocolate layer may “bloom,” i.e., the crystal lattice formed by fats in the chocolate polymorphically transforms; or, fat deposition may occur. It is believed that the palm kernel oil found in known peanut creme may migrate to the surface of the chocolate and form fat depositions. Yet another problem can be caused by migrating peanut oil which may result in undesirable chocolate softening.

Many blooming problems are associated with the migration of oils between adjoining layers. Oil migration and the resulting bloom on the outer surface of the chocolate often leads to confections that are discolored, hazy, and/or greasy in appearance. Upon consumption, fat bloom in confections may lead to a consumer experience that is not as pleasing in taste and/or mouth feel. Worse yet, a consumer may reject the confection as old, stale, or generally unappetizing in appearance. While they are similar, fat bloom and fat deposition are not the same.

Fat deposition, which resembles fat bloom, is another phenomenon generally attributed to fat/oil migration. Specifically, when a confection is exposed to an elevated temperature, a fat in an inclusion may migrate through the chocolate layer and “deposit” on the surface of the chocolate. The deposit may re-solidify upon cooling and leave a white fat spot, streak or speck. Typically, these white specks will appear on the surface of the chocolate directly above areas close to an inclusion below the surface of a chocolate confection. In the case of inclusions protruding from the surface of the chocolate, the white specks may even form on the surface of the protruding inclusion, e.g., around the circumference of the inclusion. The white specks are typically slivers that are approximately 1 to 4 millimeters in length.

The food product industry has continually attempted to extend the shelf life and/or consumer acceptability of food products. Most proffered solutions involve affecting physicochemical changes in the layers themselves, which includes the use of tempering methods, additives, and control over the types and levels of migrating fluids, e.g., fats, in the layers. See, e.g., U.S. Pat. Nos. 6,210,739; 5,849,353; 5,576,045; 5,554,408; 5,431,948; 5,324,533; 5,080,920; 5,023,102; 5,023,099; 4,923,708; 4,446,166; and 4,041,188. Unfortunately, many of these solutions increase food product manufacturing costs and/or complexity, and/or do not adequately resolve the above-described issues.

U.S. Pat. No. 5,385,744, to Cain, et al., is directed to resolving outer chocolate bloom problems with chocolate-encapsulated fillings. This patent indicates that a solution to this problem through the use of a barrier layer between the liquid filling and the coating would complicate the production process and would often have a negative influence on product mouthfeel. The patent then concludes, “the problems associated with the application of the prior art products can be solved by using a specific hardstock fat in the encapsulated filling.”

Accordingly, there remains a need for a simple, effective, and cost conscious way to inhibit the migration of fat from the core of sugar shelled inclusions into a chocolate matrix where the migrating fat results in degradation of the visual and/or organoleptic properties of the confections. Any useful technique must not only inhibit fat migration, but also maintain the sensory experience desired from the sugar shelled inclusion.

### SUMMARY OF THE INVENTION

The present invention is directed to a simple and effective way to maintain the outer aesthetics of a chocolate confection containing one or more sugar shelled inclusions for an extended period of time.

One embodiment of this invention is directed to a stable chocolate confection having at least one sugar coated confectionery inclusion, said confectionery inclusion comprising: (i) an outer sugar shell; (ii) a fat-containing edible barrier layer substantially surrounded by said sugar shell; and (iii) a fat-containing edible core surrounded by said barrier layer, wherein said barrier layer and said edible core differ in composition and a barrier layer:core weight ratio is at least about 0.1:1. The composition of the fat-containing barrier layer is selected and employed in an amount effective to inhibit the migration of fats from the edible core through cracks or openings in the sugar shell that result in the visible and/or organoleptic degradation of the chocolate matrix.

Another embodiment of this invention is directed to a method for preparing a stable chocolate confection containing one or more sugar shelled inclusions, said method comprising the steps of:
(a) contacting (1) at least one sugar shelled confectionery having (i) an outer sugar shell; (ii) a fat containing edible barrier substantially surrounded by said sugar shell; and (iii) a fat containing edible core surrounded by said barrier layer, wherein said barrier layer and said edible core differ in composition and a barrier:core weight ratio is at least about 0.1:1; and
   (2) liquid chocolate; and
(b) cooling said liquid chocolate containing said one or more inclusions.

A particularly preferred embodiment of this invention is directed to a stable chocolate confection having: a chocolate matrix with one more sugar shelled inclusions, said inclusions comprising an (i) outer hard panned sugar shell; (ii) a fat-containing edible barrier layer substantially surrounded by the sugar shell, the barrier layer having at least about 0.5% less liquid fat at 25° C.; (iii) a fat-containing edible core which is surrounded by said barrier layer and has about 5% to about 65% liquid fat at 25° C.; and a barrier layer:core weight ratio is about 1.1:1 to about 0.1:1.

Unless otherwise stated, all units of measure are standard SI units and any proportions are measured by weight.

### BRIEF DESCRIPTION OF THE DRAWINGS

Reference is now made to the figures.

FIG. 1 depicts a cross-section of an embodiment of the present invention comprising a confectionery inclusion comprising a fat-containing edible core, 10, a fat-containing barrier layer, 20, and a sugar shell, 30, in a chocolate matrix, 40. This embodiment is a lentil shaped confection.

FIG. 2 depicts yet another cross-section of an embodiment of the present invention comprising a plurality of confectionery inclusions comprising a fat-containing edible core, 10, a fat-containing barrier layer, 20, and sugar shell, 30, in a chocolate matrix, 40. This embodiment is a bar shaped confection with lentil shaped inclusions.

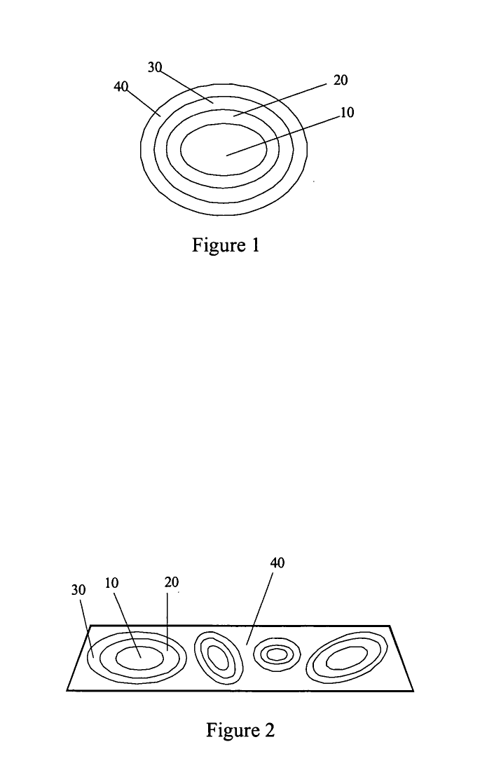

### DETAILED DESCRIPTION OF THE INVENTION

As used herein, the root word “inhibit” and its various forms in reference to fluid migration is intended to refer to the temporary or permanent slowing, reduction, or cessation of fluid migration between the otherwise intimately-contacting layers of a food product via interposition of a barrier layer. While the barrier layer may or may not inhibit the migration of a fluid out of food product layers, it should inhibit the migration of fluid into other food product layers and should act to extend the consumer acceptable visual appearance life of the multi-layer food product. Accordingly, “migration” refers to the travel of fluid into or out of a layer but does not necessarily include both. For example, the barrier layer may act as a sponge and absorb fats that migrate from the edible core.

As used herein, the term “barrier layer” is intended to refer to a layer that is substantially surrounded by a sugar shell and which surrounds an edible core. The barrier layer serves to inhibit the migration of fluid between the edible core and chocolate matrix. As discussed further below, any edible material that serves as a fluid pathway inhibitor may be utilized as a component of the barrier layer. It is preferred the barrier layer contain at least some components in solid form, more preferably in powder or crystalline form. Preferred barrier layer components include, e.g., sugar (including, for example, sucrose, dextrose, maltose, corn syrup solids and other carbohydrates), cocoa solids, cocoa powder, peanut or other nut solids, peanut flour, chocolate refinings, edible fats, and combinations thereof. Particularly preferred are sugar, cocoa solids, and combinations thereof. Preferably, any food solids in the barrier layer comprise particles with a median size of about 100 microns or less, more preferably about 50 microns or less, even more preferably about 20 microns or less.

The barrier layer preferably comprises edible fat. The amount of fat in the barrier layer is generally in the range of about 10% to about 50% by weight of the barrier layer, preferably about 20% to about 40% fat, and more preferably 25 to 35%. The non-fat solids content of the barrier layer will generally be in the range of about 50 to about 90% by weight of the barrier layer, preferably about 60 to about 80% and more preferably about 65 to about 75%. In addition, the barrier layer employed in the present invention will contain at least about 0.5% less liquid fat at 25° C. than the edible core, preferably at least less than about 1%, more preferably at least less than about 2%, even more preferably at least less than about 3.0%, yet more preferably at least less than about 5% and most preferably at least less than about 10%.

The barrier layer may also be differentiated from the composition of the edible core by the amount of non-cocoa butter compatible fat present. Cocoa butter compatible fats are well known and include, for example, cocoa butter, cocoa butter equivalents, milk fat and milk fat equivalents. Non-cocoa butter compatible fats are also well known to those skilled in the art and a recitation of such fats is not required herein. Generally the barrier layer will contain at least 10% less non-cocoa butter compatible fat than the edible core, preferably at least 20% less, more preferably at least 30% less, even more preferably at least 50% less, yet more preferably at least 70% less and most preferably at least 90% less. The amount of non-cocoa butter compatible fat present in the barrier layer may be 40% or less by weight of the fat in the barrier, preferably 30% or less, more preferably 20% or less, even more preferably 10% or less. The barrier layer may also be substantially free of non-cocoa butter compatible fats.

As used herein, the term, “edible core”, is intended to refer to the middle portion of the confection that is surrounded by the barrier layer of a confection, i.e., a center. It is preferred the edible core contain at least some components in solid form, more preferably in powder or crystalline form. Exemplary edible core components include, e.g., sugar, flour, starch, protein, cocoa solids, cocoa powder, peanut or other nut solids, peanut creme, peanut butter, peanut flour, chocolate refinings, edible fats, and combinations thereof. It is well known that peanut butter has a standard of identity and peanut creme includes replacement fats in order to achieve desired physical properties. Particularly preferred are peanut products such as peanut nut meat, peanut cream, peanut butter, peanut flour and combinations thereof.

It is preferred that the edible core comprises fat, preferably from about 15% to about 60% edible fat by weight of the core, more preferably from about 30% to about 45% edible fat, and most preferably from about 35% to about 40% edible fat. Preferred fats for use in the edible core include, e.g., cocoa butter and its equivalents, peanut or other nut fat, partially hydrogenated oils (e.g., vegetable oil), and combinations thereof. The non-fat solids content of the edible core will generally be in a range of 50% to 75% by weight of the core, preferably about 55% to about 70% and more preferably about 60% to about 65%. A preferred edible core is peanut butter or peanut creme. Generally, the liquid fat content of the edible core is in a range of about 5% to about 65% by weight of the total fat of the edible core at 25° C., preferably about 15% to about 55%, more preferably about 25% to about 45% and most preferably 35% to 45%. The non-cocoa butter compatible fat content of the edible core will generally be in a range of about 10% to about 100% by weight of the total fat content of the edible core, preferably about 35% to about 95%, more preferably about 50% to about 90% and most preferably about 60% to about 85%. An exemplary non-cocoa butter compatible fat that is preferred in the present invention is palm kernel oil (which may be fractionated) particularly when a peanut based product is used in the edible core.

As used herein, the term,“sugar shell”, is intended to refer to a soft panned, hard panned or film coated sugar shell, and may include any appropriate inorganic or organic coating materials. Preferably, for candy such as chocolate and other confectioneries, the layer is formed from, for example, sucrose, fructose, or dextrose. The layer preferably comprises sucrose. The application of a sugar shell to confectioneries may be carried out, e.g., by “hard panning”, “soft panning” or film coating—all of these processes being well known to those skilled in the art. See, e.g., B. Minifie Chocolate, Cocoa, and Confectionery, 3^{rd} edition, p. 506 (1999).

Panning and film coating are industrial processes for preparing coated edible products, such as confections and pharmaceuticals. Panning and some coating processes are performed in a rotating drum or “pan”. Panning is a well known process often used for the application of sugar-based coatings, such as, e.g., sucrose or dextrose, to masses of centers to produce coated products. Typically, multiple applications of a concentrated sugar syrup are used to build up the uncolored portion of a sugar shell. This is followed by multiple applications of a concentrated sugar syrup containing colorant. The term “film coating” is used with regard to applying coatings to masses of centers, where the coating material typically comprises film forming components, such as a modified cellulose, e.g., hydroxypropyl-methylcellulose that is continuously applied to the centers until the desired coating thickness is achieved.

The panning process comprises the repetitive application of thin layers of a coating solution or composition onto an intermixed mass of centers, while mixing the mass of centers, and optionally drying of each layer of coating solution or composition during which the sugar in the coating crystallizes between the application of layers. In contrast, as the film coating process does not require the crystallization of a sugar shell, film coating is a continuous process, typically comprising the simultaneous application of a coating solution, distribution by mixing, and drying of the coating solution. That is, the film coating sprayers are not turned off during the film coating process, but, instead, are run continuously until the desired film coating is applied. The film coating solutions typically contain less than about 10 percent solids, as higher concentrations would be too viscous to spray. However, in each process, coating material is built up on the center to form the desired shell or coating.

If the coating is to be colored, an edible colorant is added to the coating solution in the later stages of the coating process. For film coating, a flow of colorant is turned on, and added to the film forming composition flow to the sprayer. For a panned confectionery, following the application of a number of layers of concentrated syrup coating solution td build up the sugar shell, a number of applications of a concentrated sugar solution containing a colorant are applied to provide the color coat. The color coat can require up to 20 applications of a colored coating solution to achieve the desired color. This is because the amount of dye that can be solubilized in the sugar solution is relatively low due to the high sugar solids content of the sugar coating solution. As a result, the process of building the shell, including the coloring steps, can take many hours. Film forming processes are similarly limited due to the relatively low solubility of the colorant in the film forming component.

For sucrose-based solutions used in hard panning, the preferred concentration is about 60 to about 80 Brix, more preferably about 65 to about 77 Brix, and, most preferably, about 76 Brix, to maximize solution drying rates while avoiding the crystallization issues typically associated with higher solids content solutions. It will be appreciated the sugar-containing layer's composition may be varied depending on the desired product as well as process parameters. The sugar-containing layer preferably comprises at least 98% sugar after any drying. The sugar shell employed in the present invention substantially surrounds the barrier layer. As used herein, “surrounds” encompasses sugar shells which may only be considered substantially surrounded due to cracks or imperfections in the shell.

As used herein, the terms, “negative impact”, or “adverse impact”, is intended to mean that an intended consumer would object to an experience resulting from an aesthetic encounter with the food product and therefore be less likely to consume the food product because of any added layer(s) or components(s). It is preferred any added component to the barrier layer does not adversely impact the food product while still allowing the barrier layer to inhibit fluid migration. Designing an additional layer that avoids an adverse impact on the food product can be carried out in several ways.

By way of non-limiting example, the added layer's component(s) may be used in amounts that do not adversely impact the food product while still providing fluid migration inhibition. These amounts may vary for different layers and multi-layer food product combinations depending on the relative strength of the added layer's aesthetics to those of other food product components' aesthetics or of the food product as a whole. Another non-limiting method may include grinding or milling layer component(s) to finer median particle sizes to minimize a “gritty” mouth sensation relative to the food product as a whole. A third non-limiting method may include using only those layer components or combinations that, while still providing migration inhibition, are compatible in flavor and mouth feel with the food product as a whole. Other ways will be apparent to the skilled artisan.

As used herein, the term “cocoa powder” is intended to refer to the press cake obtained by removing at least part of the cocoa butter from cocoa liquor. This removal may be performed via mechanical pressing or other extraction or stripping means. The press cake may be ground or milled to produce particles of varying median sizes including powder. Cocoa typically contains 10-12% fat on the low side and 22-24% fat on the high side, 19-23% protein, 10-13% starch, 1-3% sugars, 19-23% cell wall constituents, 3-5% organic acids, 4-8% ash, and 2-5% moisture. Cocoa may also contain polyhydroxyphenols, theobromine, and caffeine. Cocoa is also available in reduced fat and fat free forms. Fat-containing, reduced fat, and fat free cocoas are commercially available; and, all are viable components of a confection within the present invention. Cocoa solids or mass particles refer to any cocoa bean products not falling within the above recipe for cocoa powder.

As used herein, the term “chocolate refinings” refers to the products obtained during many chocolate manufacturing processes. In the manufacture of chocolates, an important step is the use of a refiner or other milling equipment to reduce the particle size of most solids, that comprise the chocolate recipe, to a desired size. Typical solids include cocoa mass particles, sugar crystals, and milk solids. The feed stream to the refiner typically includes the full chocolate recipe except for an emulsifier, which is often lecithin, and only some or no fat added, with cocoa butter and milk fat being the most common added fats. The discharge from the refining process is a powdery material with typical particle sizes of about 15 to about 60 microns, although other sizes are possible and contemplated. The refining process discharge tastes very similar to finished chocolate albeit with a different texture. Typically, these refinings are further processed into smooth, liquid chocolate; however, for use in the present invention, the refinings may be used directly from the refiner prior to the addition of emulsifiers and/or additional fats and while they are still solids, a preferred form.

As used herein, the term, “peanut flour”, refers to a product obtained by pressing, grinding, or milling peanuts into particulate form. Peanuts contain a substantial amount of oil, approximately 50%, that causes the pressed or milled product to be pasty or creamy. To arrive at peanut flour, therefore, at least some of the natural oils or fats must be removed. Although typical peanut flour contains about 12% to almost 14% fat and has the consistency of a particulate solid, a flour with more or less than about 12% to 14% fat or oil may be used. Peanut flour is known to skilled artisans and is available commercially. Other nut flours or solids may also be used in the present invention.

As used herein, the term “edible fats” refers to any edible fat or oil. Non-limiting examples include cocoa butter, cocoa butter equivalents, palm oil, coconut oil, vegetable oil, hydrogenated vegetable oil, partially hydrogenated vegetable oil, anti-bloom fats, milk fats, and combinations thereof. Cocoa butter and its equivalents are preferred fats for the barrier layer. The liquid, solid or semi-solid form of any of the above-listed fats may be used in the present invention and all forms are known to skilled artisans and available commercially.

The chocolate matrix may be any size and any shape including, for example, bite-sized candy bars, full-sized candy bars, lentils, spheres, non-spherical confections, substantially planar confections, bite- or full-sized candy bars comprising lentil-shaped confections, and the like. The inclusions may be completely surrounded by the chocolate matrix or only partially surrounded, i.e., a portion of the inclusion may not be covered by the chocolate matrix. It is important to note that other edibles and/or layers may be disposed between any of the layers of the present invention.

The chocolate matrix is chocolate, milk chocolate, dark chocolate, compound coatings, confectionery coatings, and combinations thereof. As used herein chocolate, both for the matrix and barrier, is understood to mean standard of identity (SOI) chocolate or non-SOI chocolate, including compound coatings, with SOI chocolate being preferred in the present invention. Again, it is important to note that other edibles and/or layers may be disposed between any of the layers of the present invention. For example, the sugar shell may have a wax layer applied thereto. Further, the chocolate matrix does not necessarily have to cover the entire inclusion.

The chocolate matrix must contain at least one sugar coated confectionery inclusion, and preferably will contain a plurality of sugar coated confectionery inclusions. Preferably the sugar coated confectionery inclusions will be present in the chocolate matrix in an amount of about 5% to about 50% by weight of the chocolate matrix and inclusions, more preferably about 15% to about 30% by weight and most preferably about 20% to about 25% by weight.

If the chocolate matrix and/or edible core contain temperable fats, e.g., the cocoa butter in chocolate, it is preferred at least one of these layers is tempered, if possible, since this has been shown to increase the efficacy of the present invention and/or may extend the list of potential confection components that may be used effectively to inhibit fluid migration between the edible core and chocolate matrix.

As discussed, the migration of fluids between the edible core and the chocolate matrix may pose an obstacle to attaining at least some consumer's acceptance of, and satisfaction with, the stable confection, especially if the food product has been exposed to temperature cycling and/or protracted storage. The migrating fluids of primary concern are typically fats and oils such as, for example, peanut fat or palm kernel oil. The problem is of particular concern when fats migrate into the chocolate matrix and are readily perceivable by a consumer upon opening the package. The fats of particular concern are those that are incompatible with cocoa butter, e.g., vegetable fat and peanut oil.

Without wishing to be bound by theory, it is believed the barrier layer acts, at least temporarily, as a sacrificial layer and is unperceivable from the outside of the intact confection. It is preferred the barrier layer be overlaid at a barrier layer:edible core weight proportion of at least about 0.1:1, more preferably at least about 0.2:1, and most preferably at least about 0.3:1. Higher barrier layer:edible core ratios will provide greater benefit but may detract from overall flavor impression of the inner layer. Accordingly, the barrier layer:core weight ratio should only be high enough to achieve the desired affect. Generally, the range may be from about 3:1 to about 0.1:1. A preferred range is about 1.1:1 to about 0.1:1, more preferably about 0.9:1 to 0.2:1 and most preferably 0.6:1 to 0.3:1. To further increase the barrier layer's efficacy, it is also preferred the barrier be overlaid onto the edible core as uniformly as possible, preferably in a substantially uniform manner. Since high barrier to edible core ratios may mask the flavor of the inner layer, substantially uniform barrier to inner layer coverage may be desired in many cases. It should also be apparent that while the barrier layer can be made quite thick to ensure the inhibition of fat migration from the edible core, this must be balanced against the masking of sensory attributes of the edible core. Undesirable masking of peanut flavor has been found when a barrier: edible core weight ratio is about 1.3:1 or greater.

The migration inhibition of oil-soluble fluids is of particular concern since the migration of oil from and/or into a chocolate matrix may lead to fat deposition. If a chocolate on the outside of the confection is bloomed, some consumers may reject the confection. One non-limiting example is peanut creme covered with chocolate. At least some of the oils in the peanut creme migrate into the chocolate after storage and/or temperature cycling. As noted previously this problem is particularly exacerbated due to cracked sugar shells surrounding the edible core which are quite common and may occur before or after inclusion. Some of the oils in the chocolate may migrate into the peanut creme as well. The oil migration between these two layers may lead to a confection with a bloomed chocolate matrix, a confection that does not maintain its physical integrity, or both. A barrier layer, for instance chocolate, applied to the outside of a peanut creme core prior to covering it with a sugar-containing layer or sugar-shell, and, subsequently, another chocolate layer will inhibit at least some portion of the oils from migrating from the peanut creme core into the outermost chocolate layer. The result is a stable confection with increased resistance to temperature cycling, longer aesthetic shelf life, or both.

The barrier layer may be applied to the edible core in several ways. For example, dusting, panning, sprinkling, and spraying, all of which are known to skilled artisans may be used. Panning with chocolate is particularly well known to those skilled in the art.

As discussed, consideration must also be given to uniformity of barrier layer coverage. As uniformity of barrier layer coverage over the edible core increases, the barrier to edible core ratio may be decreased for the same stabilization effect.

As noted above, panning may also be used to apply the barrier layer. The process involves the gradual building of a layer around the edible core, typically substantially round or lentil-shaped pieces, by moving or rolling the pieces in a pan-like apparatus while exposing them to barrier layer component(s) in either dry or liquid form. It is particularly preferred to use liquid chocolate. The movement of the edible cores and the exposure to the barrier layer component(s) gradually builds the barrier layer around the edible cores. The barrier layer possessing edible cores may then be prepared for the addition of another layer of the confection, such as a sugar shell. It should be readily apparent that panning may be used to build any of the layers, including the sugar shell of the stable confections of this invention.

One way to sprinkle coat the confectionery pieces with a barrier layer would be to sprinkle or scatter, in liquid drop or solid particle form, the barrier layer component(s) over confectionery pieces. The barrier layer component(s) will adhere to the surface of the confectionery pieces and at least partially cover the surface of the confectionery pieces. The barrier layer possessing pieces may then be prepared for the addition of another layer of the confection. Sprinkle-coating may be used to build any of the layers.

One way to spray coat the confectionery pieces with a barrier layer is to project a liquid or gaseous spray containing the barrier layer component(s) onto the surfaces of the confectionery pieces, The barrier layer component(s) could be in liquid form or dry barrier layer component(s) in a gaseous carrier or a liquid that evaporates easily and/or is compatible with further confectionery process steps. The spray should be applied with an eye toward achieving at least partial, but preferably substantial and preferably uniform, coverage of the confectionery pieces. The barrier layer possessing pieces may then be prepared for the addition of another layer of the confection. Spray-coating may be used to build any of the layers.

In a particularly preferred embodiment of this invention, the edible core will be a peanut creme containing (i) a peanut product in a range of about 30% to about 70% by weight of the peanut creme, preferably about 35% to about 62% by weight of the peanut creme and (ii) a vegetable oil in a range of about 15% to about 40% by weight of the peanut creme, preferably about 20% to about 35% by weight of the peanut creme. The peanut product is selected from the group consisting of peanut flour, peanut solids, peanut oil and mixtures thereof. The vegetable oil is preferably palm kernel oil. When the stable confection of this invention is prepared using edible peanut creme cores containing palm kernel oil, the amount of lauric acid found in a 4 mm layer of chocolate surrounding the sugar shelled inclusion will generally be at least about 0.5% less, preferably at least about 1% less, more preferably at least about 5% less and most preferably at least about 10% less than the amount of lauric acid found in the same amount of chocolate surrounding an identical inclusion that does not have a barrier layer after both products have been cycled five times for 8 hours at 31° C. and 16 hours at 20° C. It will be apparent to one of ordinary skill in the art that if another vegetable oil is used instead of palm kernel oil that a similar relationship is expected with respect to any characterizing fatty acid of that oil. Fatty acid profile analysis for determining the concentration of lauric acid in the chocolate analyzed can be found in AOCS Cel-62 (5th Edition) (American Oil Chem. Society).

### EXAMPLE 1

Several lentil-shaped edible core pieces comprising 48% non-fat nut solids, 14% peanut fat, 23% fractionated hydrogenated vegetable fat, 12% sweeteners, and 3% minors such as flavor, salt, and preservatives, were coated with chocolate at a chocolate to inner layer ratio of 0.26:1, to produce several lentil-shaped confections. Next, a sugar shell was applied to the confections to produce hard panned sugar-shelled, lentil-shaped confections. Several of the confections were then covered with chocolate to produce a candy bar. The chocolate bar was then cycled in a cabinet for 8 hours at 31° C. and 16 hours at 20° C., i.e., one full cycle is 24 hours long. This technique was to simulate extended shelf life. A control chocolate bar having lentils comprising 48% non-fat nut solids, 14% peanut fat, 23% fractionated hydrogenated vegetable fat, 12% sweeteners, 3% minors such as flavor, salt, and preservatives, and no chocolate coating were produced and sugar shelled as above. The sugar shelled lentils were then coated with chocolate to produce a candy bar as above. The control chocolate bar was also placed in a cycling cabinet and tested at the same conditions. The bars were evaluated once during each cycle at about eight to about eleven hours into the 20° C. portion of the cycle. During the evaluation, the bars' fronts and backs were classified as: “slight”, “moderate”, and “failed”, in reference to the amount of visible fat deposition on the outer surfaces of the bars. A classification of “failed” is assigned when several fat deposits are visible on the surface of the candy bar. The control failed within one cycle, while the bar produced in accordance with the present invention showed only slight fat deposition after two (2) cycles, moderate fat deposition after four (4) cycles, and failed only after twenty-one (21) cycles. As can be appreciated, the confection produced in accordance with the present invention can tolerate much more temperature cycling during transport and shipping and will likely be received by a consumer in far better physical condition.

### COMPARATIVE EXAMPLE 1

Peanut creme centers are prepared having the following composition:

| | |
|---|---|
| Salt-Flake | 2.1% |
| Palm Kernel Oil | 25.5% |
| Sugar | 9.2% |
| Dextrose Monohydrate | 5.5% |
| Partially Defatted | 57.7% |
| Peanut Flour (20% | |
| Fat) | |

The centers are then coated with a rigid sugar shell by hard panning. The sugar shelled peanut creme confections are then mixed with tempered liquid chocolate in a mold having a bar shape and the confection is allowed to cool and solidify.

### EXAMPLE 2

Peanut creme centers are prepared using the same composition employed in Comparative Example 1. A chocolate barrier layer is panned onto the centers until the weight ratio of the barrier to center is about 0.3:1. The resulting creme centers having a barrier layer are then sugar shelled and chocolate bars are prepared in the same manner as Comparative Example 1. The chocolate bars made herein and in Comparative Example 1 are then tested as described in Example 1 and the chocolate bars of Comparative Example 1 exhibits fat deposition in significantly fewer cycles than the chocolate bar of Example 2.

### EXAMPLE 3

Chocolate bars were molded with the following inclusions:

| | Cycles For Slight |
|---|---|
| Inclusions | Fat Deposition |
| Mini Peanut Butter sugar shelled | 1 |
| confection (no barrier) | |
| Sugar shelled peanut butter confection | 2 |
| (no barrier) | |
| Sugar shelled peanut butter confection | No evidence at 24 |
| (barrier:core = 1.3:1) | cycles |

The bars containing the above-identified inclusions were placed in a cycling cabinet and exposed to 8 hours at 31° C. and 16 hours at 20° C. Slight fat deposition was indicated if 1-6 blemishes were observed on the product. This example shows the clear advantage achieved with a barrier. However, it was determined that the 1.3:1 barrier to core weight ratio resulted in masking of the peanut flavor of the inclusion in the chocolate matrix. Thus, the use of the inclusions set forth in Example 1 having about a 0.3:1 barrier to core weight ratio were preferred.

Other embodiments of the present invention will be apparent to the skilled artisan. While the appended claims distinctly point to specific embodiments, embodiments falling within the spirit and scope of the preceding specification are also encompassed.

1. A stable confection comprising a chocolate matrix having at least one sugar coated confectionery inclusion, said confectionery inclusion comprising: (i) an outer sugar shell; (ii) a fat containing edible barrier layer substantially surrounded by said sugar shell; and (iii) a fat-containing edible core surrounded by said barrier layer, wherein said barrier layer contains at least about 0.5% less liquid fat at 25° C. than said edible core and a barrier layer:core weight ratio is at least about 0.1:1.

2. The stable confection of claim 1, wherein said sugar shell is a hard panned sugar shell.

3. The stable confection of claim 2, wherein said edible core has a liquid fat concentration of about 5 to about 65% by weight of total fat of the core at 25° C.

4. The stable confection of claim 3, wherein said edible core has a non-cocoa butter compatible fat concentration of about 10 to about 100 percent by weight of total fat of the core.

5. The stable confection of claim 4, wherein said edible core has a fat concentration of about 15 to about 50 percent by weight of the core and a non-fat solids content of about 50 to about 75 percent by weight of the core.

6. The stable confection of claim 5, wherein said edible core is comprised of a peanut product.

7. The stable confection of claim 6, wherein said peanut product is selected from the group consisting of peanut nut meat, peanut flour, peanut oil, peanut butter, peanut cream and mixtures thereof.

8. The stable confection of claim 4, wherein said non-cocoa butter compatible fat is palm kernel oil.

9. The stable confection of claim 2, wherein said barrier layer contains at least 10% less non-cocoa butter compatible fat than said edible core.

10. The stable confection of claim 9, wherein said barrier layer has a fat concentration of about 10 to about 50 percent by weight of the barrier layer and a non-fat solids content of about 50 to about 90 percent by weight of the barrier layer.

11. The stable confection of claim 10, wherein a fat portion of said edible barrier is comprised of cocoa butter or cocoa butter equivalents.

12. The stable confection of claim 1 1, wherein said edible barrier is chocolate.

13. The stable confection of claim 1, wherein said chocolate matrix is in the form of a bar and said bar contains a plurality of confectionery inclusions.

14. The stable confection of claim 1, wherein the barrier layer:core weight ratio is in a range of about 1.1:1 to about 0.1:1.

15. The stable confection of claim 1, wherein a plurality of sugar coated confectionery inclusions are present in the chocolate matrix in an amount of about 5% to about 50% by weight of the chocolate matrix and sugar coated confectionery inclusions.

16. A method for preparing a stable chocolate confection containing one or more sugar shelled inclusions, said method comprising the steps of:
(a) contacting (1) at least one sugar shelled confectionery having (i) an outer sugar shell; (ii) a fat-containing edible barrier substantially surrounded by said sugar shell; and (iii) a fat-containing edible core surrounded by said barrier layer, wherein said barrier layer has at least about 0.5% less liquid fat at 25° C. than said edible core and a barrier:core weight ratio is at least about 0.1:1; and
(2) liquid chocolate; and
(b) cooling said liquid chocolate containing said one or more inclusions.

17. The method of claim 16, wherein said sugar shell is a hard panned sugar shell.

18. The method of claim 17, wherein said barrier:core weight ratio is from about 1.1:1 to about 0.1:1.

19. The method of claim 18, wherein said edible core has a liquid fat concentration of about 5% to about 65% by weight of total fat of the core and a non-cocoa butter compatible fat content of about 10% to about 100% by weight of total core fat of the core.

20. The method of claim 19, wherein said barrier layer has at least 10% less non-cocoa butter compatible fat than said edible core.
